(19) United States
(12) Patent Application Publication
(10) Pub. No.: US 2019/0082610 A1
(43) Pub. Date: Mar. 21, 2019

(54) LIGHT ENGINE CIRCUIT WITH CONFIGURABLE PULSED LIGHT OUTPUT AND HORTICULTURE LIGHTING DEVICE USING SAME

(71) Applicants: Richard Speer, Concord, MA (US); David Hamby, Andover, MA (US); John Selverian, North Reading, MA (US)

(72) Inventors: Richard Speer, Concord, MA (US); David Hamby, Andover, MA (US); John Selverian, North Reading, MA (US)

(73) Assignee: OSRAM SYLVANIA Inc., Wilmington, MA (US)

(21) Appl. No.: 15/711,091

(22) Filed: Sep. 21, 2017

(51) Int. Cl. A01G 7/04; H05B 37/02

(52) U.S. Cl. CPC A01G 7/045; H05B 37/0281; H05B 37/029

(57) ABSTRACT

In general, one embodiment of the present disclosure includes a horticulture lighting device having a plurality of LED light channels that may be selectively energized to produce a predefined light pattern. Each of the LED light channels may emit one or more wavelengths and may be pulsed at a rate that may be imperceivable to a human eye, e.g., at 120 Hz to 720 Hz. Plants may respond biochemically to light patterns that include a period of delay between pulses of light, e.g., from 500 microseconds to 5 milliseconds. The biochemical response has been shown to significantly increase plant growth, e.g., up to 100%, relative to plants grown with lighting systems that use continuous, non-pulsing light sources. Thus, aspects and embodiments disclosed herein include a horticulture device capable of emitting light patterns which introduce a predefined delay period between energizing/pulsing of LED light channels to aid photosynthesis.

### FIELD

The present disclosure relates generally to horticulture lighting devices, and in particular, to a light engine circuit with configurable pulsed light output for use in horticulture lighting devices.

### BACKGROUND

According to the U.S. Department of Agriculture (USDA), energy costs are the third biggest expense for the vast majority of growers, with lighting costs representing a significant portion of that expense. Light emitting diode (LED) light sources continue to increase in popularity due to their efficiency relative to other lamp types such as high pressure sodium (HPS) lamps. LEDs also offer granular control not available in other lamp types, which may further increase efficiency. For example, horticulture lighting devices using LEDs can be monitored and adjusted to optimize power and light exposure. LED-based horticulture lighting devices may also simplify design as reflectors, concentrators and other similar devices are not needed to amplify and direct light intensity.

In contrast, conventional horticulture lighting systems, e.g., HPS lamps, offer limited efficiency and often binary control. That is, conventional horticulture lighting devices are either on or off. When on, they emit the same fixed spectrum for every plant, although over time such lamps emit at a lower intensity due to aging. Every plant thus gets the same spectral output despite each type of plant having potentially different light requirements. Research has begun to show that some growth characteristics such as aroma, pigment, and size may be selectively targeted via specific spectral patterns. Accordingly, continued adoption of LED-based horticulture devices will depend on increased efficiency and spectrum adjustment capabilities.

### BRIEF DESCRIPTION OF THE DRAWINGS

Reference is now made to the following detailed description which should be read in conjunction with the following figures, wherein like numerals represent like parts:

FIG. 1A shows an example horticulture lighting device in accordance with an embodiment of the present disclosure.

FIG. 1B shows a plurality of horticulture lighting devices in accordance with embodiments of the present disclosure.

FIG. 2A shows an example light engine circuit having a plurality of light channels in accordance with an embodiment of the present disclosure.

FIG. 2B is an example light engine circuit for driving multiple light channels in accordance with an embodiment of the present disclosure.

FIG. 3 is an example timing diagram for driving the horticultural lighting device of FIG. 1A in accordance with an embodiment of the present disclosure.

FIG. 4 shows another example timing diagram for driving the horticulture lighting device of FIG. 1A in accordance with an embodiment of the present disclosure.

FIG. 5 is an example method for driving a horticultural lighting device in accordance with an embodiment of the present disclosure.

### DETAILED DESCRIPTION

In general, one embodiment of the present disclosure is directed to a horticulture lighting device having a plurality of LED light channels that may be selectively energized to produce a predefined light pattern. Each of the LED light channels may emit one or more wavelengths and may be pulsed at a rate that may be imperceivable to a human eye, e.g., at a frequency of 120 Hertz (Hz) to 720 Hz. Plants may respond biochemically to light patterns that include a period of delay between pulses of light, e.g., from 500 microseconds to 5 milliseconds. The biochemical response has been shown to significantly increase plant growth, e.g., up to 100%, relative to plants grown with lighting systems that use continuous, non-pulsing light sources. Thus, aspects and embodiments disclosed herein include a horticulture device capable of emitting light patterns which introduce a predefined delay period between energizing/pulsing of LED light channels to aid in photosynthesis.

In an embodiment, a horticultural lighting device includes a programmable controller, a power supply, and a light engine circuit to drive a plurality of LED light channels, which may also be referred to as simply light channels. Each light channel may include one or more LED devices to emit one wavelength or multiple different wavelengths, and may be switchably coupled to the power supply based on a driving signal. The driving signal may be a pulse-width modulated (PWM) signal. Each light channel may be independently driven via a respective driving signal, although the same driving signal may be provided to two or more light channels. Thus, light channels may be driven in phase via the same driving signal, out of phase via different driving signals, or based on a mixture of channels driven in-phase and out of phase.

A horticultural lighting device consistent with the present disclosure may further reduce the duty cycle of the driving signals to proportionally reduce the overall power consumed during operation. For example, each duty cycle may be set to less than 75%, and preferably equal to or less than 50% when in a power saving mode. Therefore, while the overall output power, e.g., in Photon Moles per day, may be about half of that of an equivalent non-pulsing source (e.g., based on a duty cycle of 50% or less), each plant may grow at a relatively normal rate based on the horticultural lighting device introducing delays that encourage/stimulate the biochemical response. Thus, in a general sense, the horticultural lighting device may include a low power mode that compensates for the same by increasing a plant's ability to efficiently process photons during photosynthesis based at least in part on predefined pulse delays.

In another embodiment, a horticultural lighting device consistent with the present disclosure may also implement a shared power supply scheme whereby a plurality of light channels are powered/energized by a shared power supply, with the shared power supply having a maximum output insufficient to energize all light channels at the same time. For example, the power supply may comprise a relatively inexpensive direct current (DC) power supply configured to output a constant voltage of 120 volts or less and a maximum current of 2 amperes (A). In this example, the horticultural lighting device may further include eight (8) light channels, with each light channel consuming 500 mA. Thus, a controller of the horticultural lighting device may ensure that only four of the eight light channels are driven simultaneously (4×500 mA=2 A), and more specifically, only that four of the eight channels are coupled to the shared power supply. The provided example is not intended to be limiting and other power supplies, light channel configurations, and total number of light channels are within the scope of this disclosure.

Thus, horticultural lighting devices consistent with the present disclosure provide numerous advantages over other approaches. For example, aspects of the present disclosure enable fine-grain control over the amount of each wavelength emitted over a given period of time, length/period of each pulse, and/or configurable pulse delays to cause biochemical responses in target plant(s). To this end, the horticultural device may include a plurality of light pattern profiles, e.g., stored in a memory, that allow the horticultural device to easily optimize light output based on the particular plant to grow and/or the particular characteristics to target during operation of the horticultural lighting device. In addition, embodiments disclosed herein allow a relatively inexpensive power supply to be shared between a plurality of light channels based on a switching scheme to ensure the sum of the total power drawn by energized channels is less than a maximum output rating of the shared power supply.

Horticulture lighting devices of the present disclosure may be utilized within a wide-range of horticultural applications including within professional greenhouses, home greenhouses, so-called “city” farming, vertical gardens, or within any other plant growing environment.

One or more elements of the present disclosure may be numerically designated, e.g., as a first, second, third, etc. element. In this context it should be understood that the numerical designation is for the sake of clarity only (e.g., to distinguish one element from another), and that elements so designated are not limited by their specific numerical designation.

As used herein singular expressions such as “a,” “an,” and “the” are not limited to their singular form, and are intended to cover the plural forms as well unless the context clearly indicates otherwise.

As used herein, the terms “substantially” and “about” when used in connection with an amount or range mean plus or minus 5% of the stated amount or the endpoints of the stated range.

The terms, “light emitting diode,” “LED,” and “LED light source” are used interchangeably herein, and refer to any light emitting diode or other type of carrier injection/junction-based system that is capable of generating radiation in response to an electrical signal. Thus, the term LED includes but is not limited to various semiconductor-based structures that emit light in response to current, light emitting polymers, light emitting strips, electro-luminescent strips, combination thereof and the like. In particular, the term LED refers to light emitting diodes of all types (including semiconductor and organic light emitting diodes) that may be configured to generate light in all or various portions of one or more of the visible, ultraviolet, and infrared spectrum. Non-limiting examples of suitable LEDs that may be used include various types of infrared LEDs, ultraviolet LEDs, red LEDs, green LEDs, blue LEDs, yellow LEDs, amber LEDs, orange LEDs, and white LEDs. Such LEDs may be configured to emit light over a broad spectrum (e.g., the entire visible light spectrum) or a narrow spectrum.

It should be understood that the ranges enumerated herein are for the sake of example only, unless expressly indicated otherwise. The ranges herein should also be understood to include all of the individual values of falling within the indicated range as though such values were expressly recited, and to encompass sub ranges within the indicated range as though such sub ranges were expressly recited. By way of example, a range of 1 to 10 should be understood to include the individual values of 2, 3, 4 . . . etc., as well as the sub ranges of 2 to 10, 3 to 10, 2 to 8, etc., as though such values and sub ranges were expressly recited.

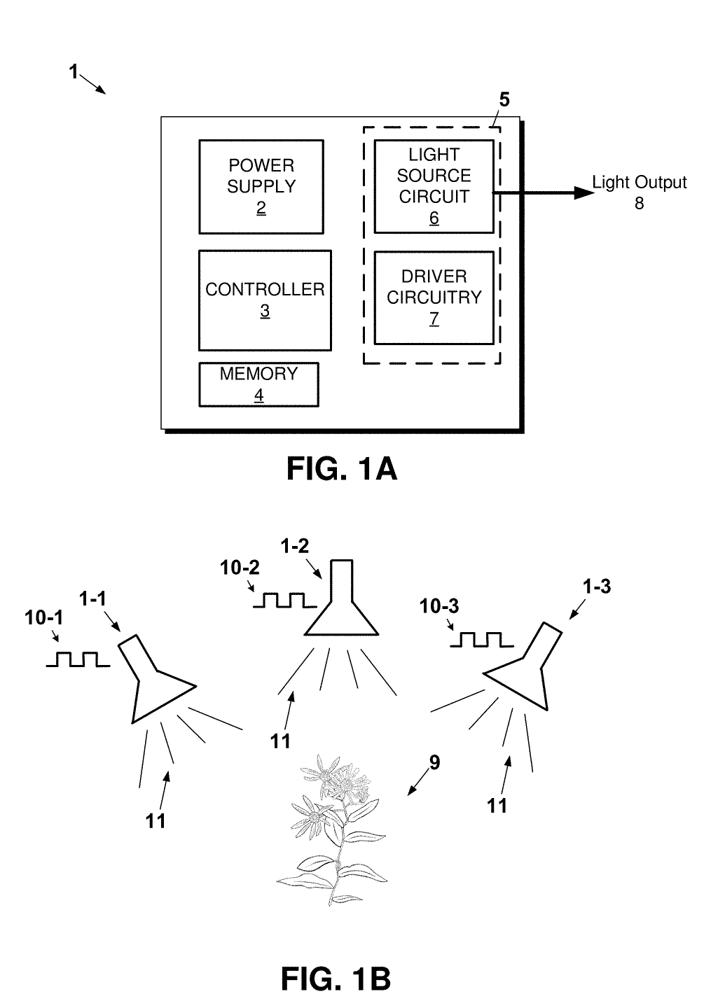

Turning to the Figures, FIG. 1A shows an example horticulture lighting device 1 in accordance with an embodiment of the present disclosure. The horticulture lighting device 1 is shown in a highly simplified form and other embodiments are also within the scope of this disclosure. As shown, the horticulture lighting device 1 may include a power supply 2, a controller 3, a memory 4 and a light engine circuit 5.

The power supply 2 may comprise any suitable power supply for driving the light engine circuit 5. For example, the power supply 2 may comprise a relatively inexpensive DC supply with a constant voltage output and a maximum current output of 500 mA to 2 A. Other power supplies are also within the scope of this disclosure, and the provided example should not be construed as limiting. The power supply 2 may be configured to source power from, for example, AC mains, battery, photovoltaic cell or other suitable power sources.

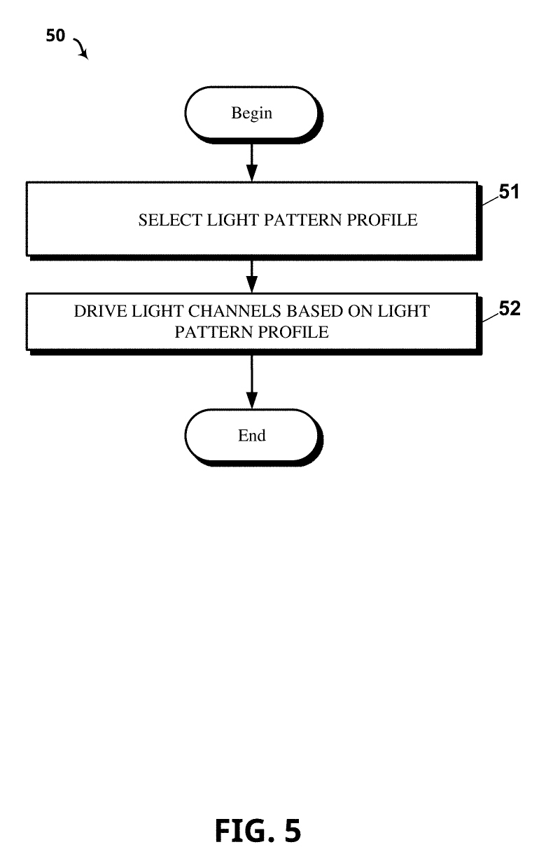

The controller 3 may comprise one processing device/circuit such as, for example, a field-programmable gate array (FPGA), Reduced Instruction Set Computer (RISC) processor, x86 instruction set processor, microcontroller, or an application-specific integrated circuit (ASIC). The controller 3 be configured to execute a plurality of instructions to carry out processes in accordance with various aspects and embodiments disclosed herein. For example, the controller 3 may be configured to execute the method/process of FIG. 5. This process may be may be implemented, for example, using software (e.g., C or C++ executing on the controller/processor), hardware (e.g., hardcoded gate level logic or purpose-built silicon) or firmware (e.g., embedded routines executing on a microcontroller), or any combination thereof.

The memory 4 may comprise, for example, a non-volatile storage device including flash memory and Read Only Memory (ROM) and/or volatile storage devices such as Random Access Memory (RAM), content addressable memory (CAM) device, Dynamic Random Access Memory (DRAM), and Static RAM (SRAM).

The memory 4 may contain a plurality a light pattern profiles. Each light pattern profile may be associated with a particular type of plant to encourage growth. In some cases, multiple light pattern profiles may be defined for each type of plant, with each of the different profiles being configured to stimulate/target specific growth characteristics. For instance, research has identified that green and red wavelengths tend to increase overall growth rates for plants. On the other hand, research has also identified that violet may enhance color, taste and aroma of plants. Thus, each type of plant may be associated with a number of light pattern profiles with each light pattern profile providing fine-grain control over color selection to target specific growth characteristics such as plant color (e.g., pigment), taste, leaf count, aroma, and growth rate, just to name a few.

In any event, each light pattern profile may further include configuration parameters that may be utilized by the controller 3 to drive N number of LED arrays (or light channels) in a time-synchronized fashion. For example, each light pattern profile may include configuration parameters such as an overall duty cycle for light output. The duty cycle may be adjusted to implement a power saving scheme. For example, a duty cycle of 50% or less may be utilized to reduce overall power consumption. In addition, configuration parameters may include fine-grain adjustments such as the ratio of a first color (or colors) relative to a second color (or colors), and duration/period for each pulse. In one example embodiment, pulse periods may be about 2 ms, although other pulse-widths are within the scope of this disclosure. The duty cycle may further correspond with a refresh rate. In an embodiment, the refresh rate (or frequency) may be between 120 Hz and 720 Hz, although other refresh rates are within the scope of this disclosure.

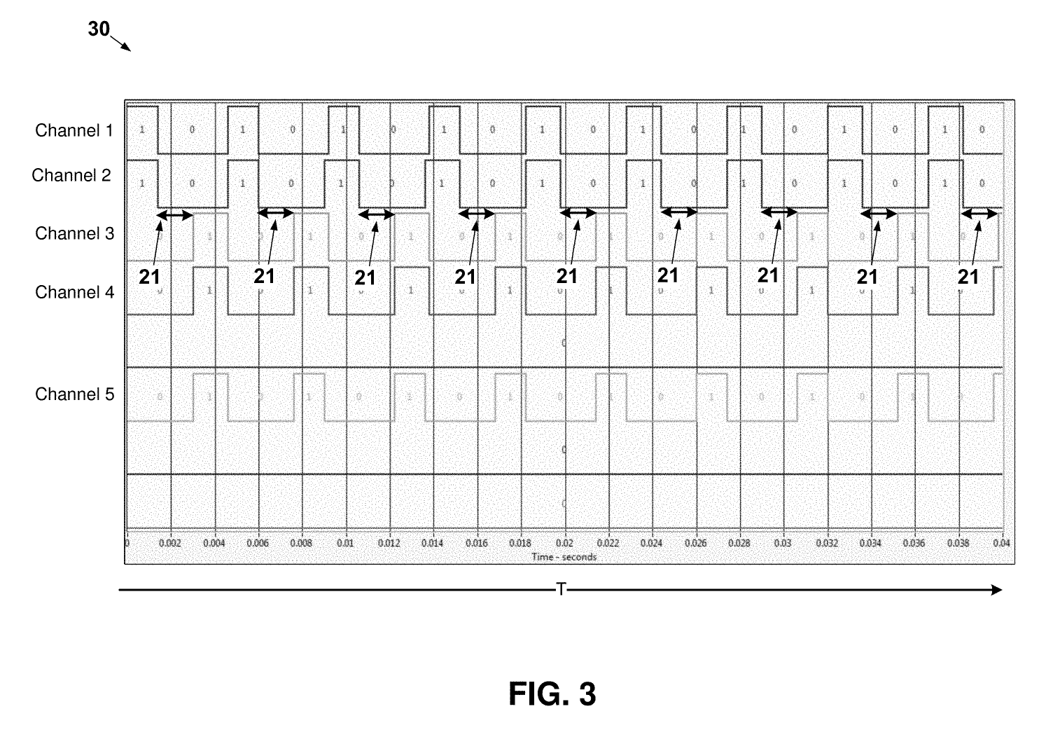

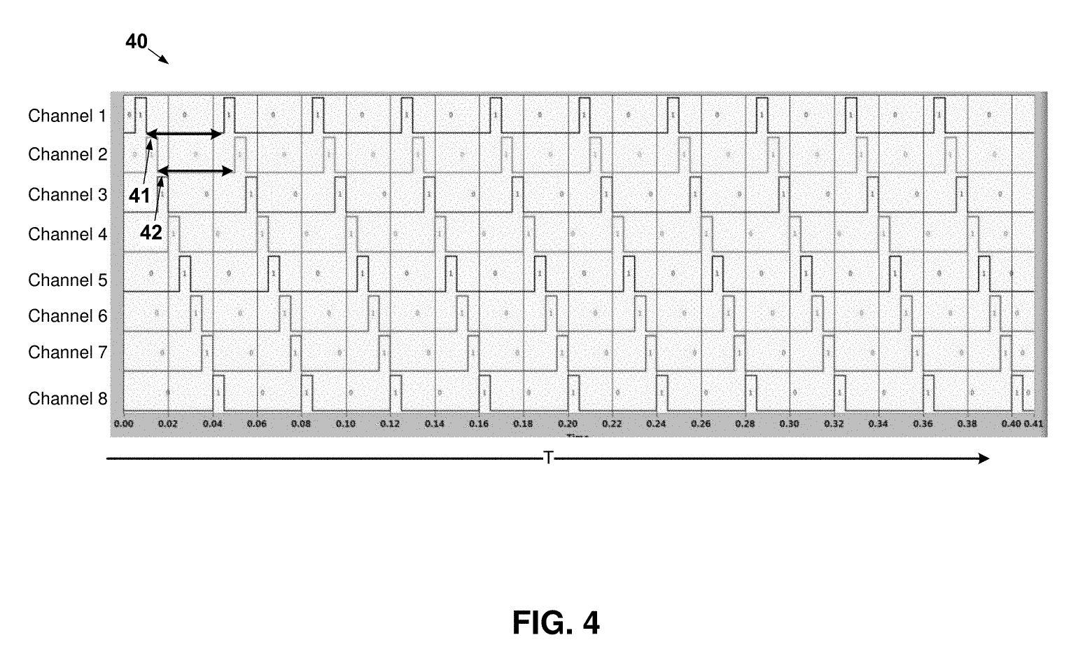

Each light pattern profile may further include a sequence parameter that establishes a channel pattern to output. For instance, one such channel pattern may cause one or more channels to pulse in a serial/sequential fashion. FIG. 3 shows one such sequential pattern in which channels 1 and 2 pulse, followed by channels 3, 4 and 5. FIG. 4 shows another example pattern in which each channel pulses sequentially, e.g., channel 1 followed by channel 2, followed by channel 3, and so on. In an embodiment, channel selection may be randomized and not necessarily follow an ordered pattern.

Each light pattern profile may further include a configuration parameter that introduces a predefined pulse delay, or off period, between pulses of light. The pulse delay, which may be referred to as simply a delay, may be applied for each channel such that a delay occurs between pulses. Alternatively, or in addition, a delay may be applied device-wide such that after N number of pulses a delay occurs which prevents all light output by the horticulture lighting device 1 for the duration of the delay. For example, as shown in FIG. 3, each pulse may be followed by a delay period 21.

Research has identified that photosynthesis operates at a millisecond scale and includes a brief period, e.g., 1-3 milliseconds, whereby received photons may be biochemically “processed” to convert the same to organic molecules to encourage growth. Thus, each light pattern may include an off-time parameter (or pulse delay) of about 500 microseconds (μs) to about 5 ms, and preferably between about 1-3 ms between light pulses. To a human eye, this delay/off time is imperceivable. To a plant, this pulsed light output with predefined pulse delays may result in more efficient biochemical conversion of photons to organic molecules, which has been shown to increase plant growth relative to continuous lighting schemes.

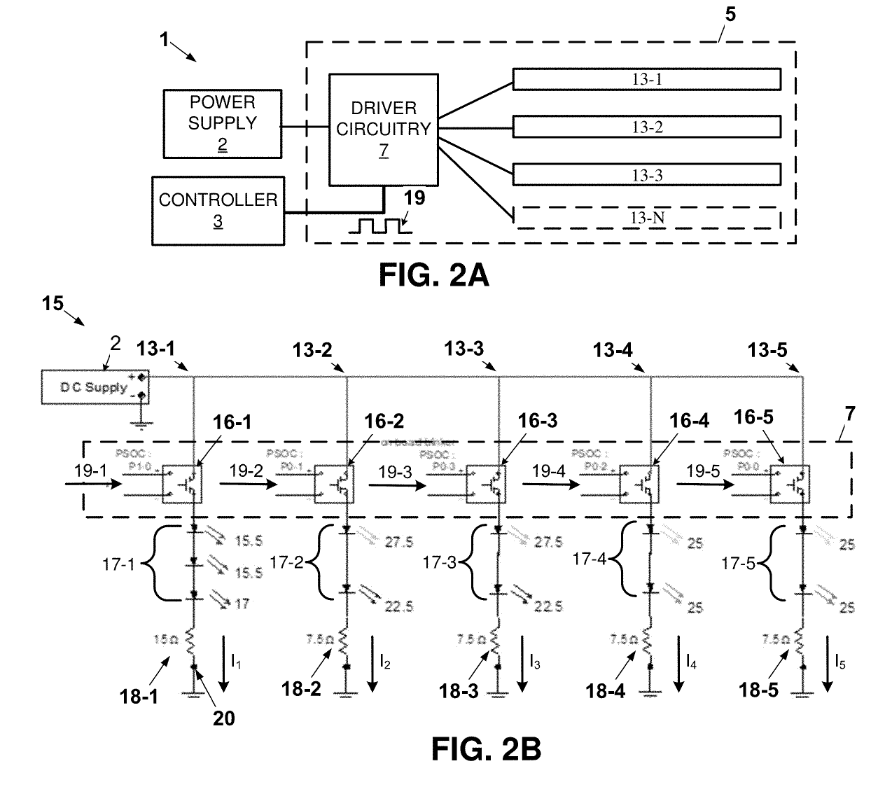

Returning to FIG. 1A, the light engine circuit 5 includes a light source circuit 6 and driver circuitry 7 to drive the light source circuit 6. The light source circuit 6 may include a plurality of LED arrays coupled in parallel with each other (see FIG. 2B). Each LED array, or LED string, may include one or more LED devices electrically coupled in series. Each LED array may include the same type of LEDs or different types of LEDs (to emit different wavelengths) depending on a desired configuration.

The driver circuitry 7 may include a plurality of switching devices such as, for example, solid-state switching devices/relays 16-1 to 16-5 shown in FIG. 2B. Each of the switching devices may be associated with a respective LED array and may be independently controlled via a driving signal, e.g. from the controller 3, to switchably couple or decouple an associated LED array to the power supply 2. Thus, each switching device and associated LED array may be accurately considered a light channel. In some cases, each light channel may include two or more associated LED arrays and the disclosure should not be construed as limited in this regard. In some cases, the signal to drive each channel of the horticulture lighting device 1 may be a pulse-width modulated (PWM) signal, which is discussed in greater detail below.

The horticulture lighting device 1 may further include a user interface (not shown) such as dip switches or other selection device to allow a user to adjust operation, e.g., to select to a particular light pattern profile and/or associated configuration parameters. In some cases, the user interface may be provided by a so-called “app” run on a smart phone or other computer device which wirelessly communicates with the horticulture lighting device 1 via, for instance, Bluetooth, WiFi (e.g., 802.11x) or other suitable wireless protocol. Thus, the horticulture lighting device 1 may include an antenna and network interface circuit to allow wireless communication.

In operation, the controller 3 may first select a light pattern profile from the memory 4 to utilize. In some cases, the memory 4 may include a single light pattern profile. The specific light pattern profile may be selected based on a user interface of the horticulture lighting device 1, as discussed above. Once selected, the controller 3 may then provide a driving signal to the driver circuitry 7 to cause a light pattern associated with the selected light pattern profile to be output as light output 8.

In some cases, the controller 3 may provide a PWM signal to each light channel. The PWM signal may comprise, for example, a plurality of bits set to 1 (ON) or 0 (OFF). Each bit may represent a predetermined period of time, with a value of 1 causing an associated array of LEDs to couple to the power supply 2 by way of an associated switch closing, and a value of 0 causing the associated switch to open to decouple the associated array of LEDs from the power supply 2 to disable or otherwise prevent light output. For instance, each bit may represent 2 ms and in a 4-channel configuration each PWM signal may include 500 samples per second. Other sample resolutions are within the scope of this disclosure and the example provided above is not intended to be limiting.

In an embodiment, the controller 3 may drive two or more selected channels in-phase, e.g., the same PWM signal is provided to two or more selected channels. Alternatively, or in addition, the controller 3 may drive two or more selected channels out of phase, e.g., a different PWM signal is provided to the two or more selected channels. Thus, the controller 3 may drive some channels in phase while others are driven out of phase, depending on a desired light output pattern.

FIG. 1B shows an example embodiment of a plurality of horticulture lighting devices 1-1 to 1-3 in accordance with an embodiment of the present disclosure. As shown, the plurality of horticulture lighting devices 1-1 to 1-3 may be synchronized to provide a specific light output pattern to aid the growth of one or more plants, e.g., plant 9. For example, each of the horticulture lighting devices 1-1 to 1-3 may drive their associated channels with PWM signals 10-1 to 10-3, respectively. Each horticulture lighting devices 1-1 to 1-3 may output a substantially similar light pattern 11 over a period of time T based on PWM signals 10-1 to 10-3 being substantially similar. In an embodiment, each of the horticulture lighting devices 1-1 to 1-3 may communicate with each other to synchronize light output 11. However, this disclosure is not necessarily limited in this regard and each PWM signals 10-1 to 1-3 may be different to vary light output 11 by each horticulture lighting device depending on a desired configuration.

Each of the horticulture lighting devices 1-1 to 1-3 may be configured to receive messages with one or more light pattern profile definitions, e.g., from a smartphone or other computer device. In response, a horticulture lighting device may store the one or more received light pattern profile definitions in an associated memory for subsequent use. Each of the horticulture lighting devices 1-1 to 1-3 may also be configured to select a particular light pattern profile during operation based on receiving a message that includes an indication of a specific light pattern profile to utilize.

FIG. 2A shows an example schematic of the horticulture lighting device 1 in accordance with an embodiment of the present disclosure. As shown, the horticulture lighting device 1 includes driver circuitry 7 to switchably couple each channel, e.g., channels 13-1 to 13-N, to a shared power supply 2. Thus, the horticulture lighting device 1 may implement a shared power supply scheme whereby each of the channels 13-1 to 13-N switchably electrically couple to shared power supply 2.

Thus, the power supply 2 may have a maximum output rating that is insufficient to power each of the channels 13-1 to 13-N simultaneously. For example, the power supply 2 may comprise a constant voltage source with a maximum current output of 2 A. Each of the channels 13-1 to 13-N may draw, for example, 0.5 A. In this case, the controller 3 may implement a time division scheme (or time sharing scheme) that ensures the sum of the current drawn for the switched ON channels is equal to or less than the maximum current output of the power supply 2. The controller 3 may therefore provide driving signal(s) 19 to driver circuitry 7 to cause the same to switchably couple only a subset of the channels 13-1 to 13-N to the power supply 2 at each instance in time, which is to say a number of light channels that is less than the total number of channels. This may advantageously allow a relatively inexpensive power supply to be utilized that may only have the capability of powering fewer than all of the channels 13-1 to 13-N simultaneously.

FIG. 2B shows an example light engine circuit 15 suitable for use in the horticulture lighting device 1 of FIG. 1, in accordance with an embodiment of the present disclosure. As shown, the light engine circuit 15 includes a plurality of LED strings/arrays 13-1 to 13-5, which may also be referred to as channels 13-1 to 13-5, electrically coupled with each other in parallel. Although the light engine circuit 15 of FIG. 2B includes five (5) channels, other channel numbers are within the scope of this disclosure. For example, the light engine circuit 15 may have 2, 3, 4, 10, or N number of channels depending on a desired configuration.

In any event, each of channels 13-1 to 13-5 include a switching device, e.g., switching devices 16-1 to 16-5, one or more LEDs, e.g., LEDs 17-1 to 17-5, and a resistor device, e.g., resistor devices 18-1 to 18-5. Each switching device, associated LED(s) and resistor device may be electrically coupled in series, as shown. Each of the channels 13-1 to 13-5 may be electrically coupled in parallel relative to each other such that a varying amount of current is drawn by each light channel.

In more detail, a first end/terminal of each of the channels 13-1 to 13-5 may be electrically coupled to a terminal of the power supply 2. The first terminal of each of the channels 13-1 to 13-5 may be electrically coupled to a first end of switching devices 16-1 to 16-5, respectively. Each of the switching devices 16-1 to 16-5 may comprise, for example, a solid state relay or other suitable switching device. Each of the switching devices 16-1 to 16-5 may form at least a portion of the driver circuitry 7. Each of the switching devices 16-1 to 16-5 may be configured to receive signals 19-1 to 19-5, respectively, to switchably couple the power supply 2 to each respective channel to energize the same. Likewise, signals 19-1 to 19-5, or a lack thereof, may be utilized to decouple the power supply 2 from each channel. The signals 19-1 to 19-5 may be generated by the controller 3 in FIG. 2A.

Continuing on, each channel 13-1 to 13-5 may further include one or more LEDs electrically coupled in series with an associated switching device. As shown, each channel includes an array of LEDs 17-1 to 17-5, respectively. Each array of LEDs may be substantially similar, e.g., configured to emit the same wavelength, or may be different. For example, the array of LEDs 17-1 may include three red LEDs. On the other hand, each of the LED arrays 17-2 to 17-5 may include LEDs configured to emit two or more different wavelengths. For instance, LED arrays 17-2 and 17-3 may include white and blue LED combinations while LED arrays 17-4 and 17-5 may include white and green combinations. Thus, each light channel may include one or more single color LEDs, or may include a number of different color LEDs in various combinations, e.g., two red and a single blue, three greens and two reds, and so on. In some cases, some channels may be configured with single color LEDs while other include a mix of colors, depending on a desired configuration.

Each of the light channels 13-1 to 13-5 may include a respective one of resistors 18-1 to 18-5, to determine a branch current, e.g., I₁ to I₅, for each channel. For instance, in channel 13-1 three (3) red LEDs may be electrically coupled in series which introduces a voltage drop proportional to the number of LEDs. To ensure a particular amount of current within channel 13-1, a resistor value may be chosen based on Ohm's law, I₁=(V_{supply}−V_{LED})/R, where V_{supply} is the output voltage of the power supply 2, V_{LED} is the voltage drop of the LEDs and R is the resistor value.

Therefore, each branch current I1 to I5 may be different depending on the particular LEDs and resistor value chosen. As discussed above, the power supply 2 may be limited in that the total output current may be insufficient to power each of channels 13-1 to 13-5 simultaneously. The switching devices 16-1 to 16-5 may therefore ensure that the particular channels switched ON do not exceed the maximum current for the power supply 2.

In an embodiment, each resistor 18-1 to 18-5 may provide a measurement terminal, e.g., measurement terminal 20, for measurement purposes. The measurements may be utilized by the controller 3, for example, to detect a short or open circuit for each light channel. The signal measured at terminal 20 may be used to signal an open circuit, e.g., when I₁=0, or a short circuit, e.g., where V_{LED} is lower by a predefined number of volts which may result in the current I₁ exceeding a predefined threshold. In this example, an alarm or other indicator may visualize the fault condition in the event a short/open circuit is detected. In such cases, operation may continue but with the faulted light channel being disabled until the error condition is remedied.

In an embodiment, a measurement terminal of each of channels 13-1 to 13-5 may further allow the amount of light per channel to be quantified, for instance, in Photon Moles/Day. For example, the amount of light may be based on the wavelength for each LED, LED efficiency and resistor value and integrated based on time. The amount of light may be determined by the controller 3 and displayed to a user for each channel and/or in total via an “app” or other user interface.

Turning to FIG. 3, an example timing diagram 30 shows a PWM signal being applied to plurality of channels, and more particularly, to a switching device associated with each channel, in accordance with an embodiment of this disclosure. As shown, each channel may correspond with a light channel of the horticulture lighting device, e.g., Channel 1 may correspond with channel 13-1, Channel 2 may correspond with Channel 13-2, and so on.

Channels may be driven in-phase such as Channels 1 and 2, whereby the same or substantially same signal is applied to each to ensure ON/OFF times within sub-millisecond tolerances, for instance. On the other hand, some channels may be driven out of phase. For example, while Channels 1 and 2 are driven in phase, Channels 3, 4 and 5 may be driven out of phase. In this example, a first signal may be applied to Channels 1 and 2 while a second signal is applied to Channels 3, 4 and 5. In any such cases, the driver circuitry 7 may implement a plurality of off periods 21 between pulses over a given time T. The off periods 21 may measure between 500 microseconds and 5 milliseconds, and preferably between about 1 millisecond and 3 milliseconds. The off periods 21 may be randomized and/or adjusted during operation (e.g., based on a configuration parameter). The off periods 21 may be utilized to prevent light output by the horticulture device 1 for a period found to be sufficient to cause a biochemical response, as previously discussed, and increase efficiency of photosynthesis in plants.

In an embodiment, the refresh rate for the horticulture device may be between 120 Hz and 720 Hz. This disclosure has identified that utilizing the horticulture lighting device 1 with a pulsed lighting scheme, as variously disclosed herein, found that plant growth increased by a factor of two relative to non-pulse, continuous light sources, e.g., based on comparing dry weight of the plant divided by daily accumulated light for plants grown with pulsed light versus non-pulsed light.

FIG. 4 shows another example timing diagram 40 for PWM signals being provided to a plurality of light channels to drive the same sequentially, in accordance with an embodiment of the present disclosure. As shown, each channel may correspond with a light channel of the horticulture lighting device, e.g., Channel 1 may correspond with channel 13-1, Channel 2 may correspond with Channel 13-2, and so on. As shown, each light channel includes a predefined delay between subsequent pulses. For example, channel 1 includes a delay 41 between a first and second pulse. Likewise, channel 2 includes a delay 42 between first and second pulses. In addition, each channel is driven sequentially starting from channel 1 and continuing up to channel 8 before the pattern repeats.

FIG. 5 shows an example method 50 for driving a plurality of light channels, in accordance with an embodiment of the present disclosure. The method 50 may be performed by the horticulture lighting device 1 of FIG. 1. The method 50 includes selecting a light pattern profile in block 51. For example, memory 4 may store one or more light pattern profiles that may be selected. The light pattern profile may include configuration parameters for driving a number of LED arrays (or light channels) in a time-synchronized fashion. In some cases, the horticulture lighting device 1 may include only a single light pattern profile, or may include multiple light patterns to target specific types of plants and/or plant attributes. The method 50 then includes driving light channels based on the selected light channel pattern in block 52. Driving the light channels may include, for instance, providing signals to each of the light channels, e.g., light channels 13-1 to 13-N. Based on each signal, a switching device associated with each light channel may switchably couple an associated array of LEDs to a power supply. In an embodiment, signals provided to each light channel may include a PWM signal. Each PWM signal may include one or more pulse delays, e.g., 1-3 ms delays between pulses, or the collective PWM signal may define pulse delays whereby no light is output for periods of time measuring between 500 microseconds to 5 milliseconds, or in some cases, about 1-3 milliseconds.

In one aspect of the present disclosure a horticulture lighting device is disclosed. The horticulture lighting device comprising a power supply, a light engine circuit having at least a first and a second light channel for emitting one or more wavelengths, and a switching arrangement to selectively couple the first and second light channels to the power supply independent of each other, and a controller electrically coupled to the light engine circuit, the controller to provide a signal the light engine circuit to cause the first and second light channel to emit a pulsed light pattern over a period of time T, the pulsed light pattern including one or more pulse delays during time T to prevent light output for a predefined period and cause a biochemical response in a plant during photosynthesis.

In another aspect of the present disclosure a method for driving a plurality of light channels of a horticulture lighting device is disclosed. The method comprising providing, by driver circuitry, a first signal to a first light channel, providing, by driver circuitry, a second signal to a second light channel, and outputting a predetermined light pattern by a plurality of light emitting diodes (LEDs) over a period of time T based at least in part on the first and second signals, the predetermined light pattern including one or more pulse delays to prevent light output by the first and second light channels for a predetermined period of time to cause a biochemical response in a target plant.

Other embodiments of the disclosure will be apparent to those skilled in the art from consideration of the specification and practice of the disclosure provided herein. It is intended that the specification and examples be considered as exemplary only, with a true scope and spirit of the disclosure being indicated by the following claims.

What is claimed is:

1. A horticulture lighting device comprising:
a power supply;
a light engine circuit having at least a first and a second light channel for emitting one or more wavelengths, and a switching arrangement to selectively couple the first and second light channels to the power supply independent of each other; and
a controller electrically coupled to the light engine circuit, the controller to provide a signal to the light engine circuit to cause the first and second light channel to emit a pulsed light pattern over a period of time T, the pulsed light pattern including one or more pulse delays during time T to prevent light output for a predefined period and cause a biochemical response in a plant during photosynthesis.

2. The horticulture lighting device of claim 1, wherein each of the one or more pulse delays are at least 1 millisecond in duration.

3. The horticulture lighting device of claim 1, wherein each of the one or more pulse delays are between 500 microseconds and 3 milliseconds.

4. The horticulture lighting device of claim 1, wherein each of the first and second light channels include a respective switching device, one or more light emitting diodes, and a resistor device electrically coupled in series.

5. The horticulture lighting device of claim 4, wherein the first and second light channels are electrically coupled in parallel.

6. The horticulture lighting device of claim 1, wherein the first light channel includes a first plurality of light emitting diodes (LEDs) and the second light channel includes a second plurality of light emitting diodes (LEDs), wherein the first plurality of LEDs emit at least one wavelength different from that of wavelengths emitted by the second plurality of LEDs.

7. The horticulture lighting device of claim 1, wherein the signal provided by the controller is generated by the controller based on a selected refresh rate, the selected refresh rate being between 120 Hertz (Hz) and 720 Hz.

8. The horticulture lighting device of claim 1, wherein the signal provided by the controller is a pulse-width modulated (PWM) signal.

9. The horticulture lighting device of claim 8, wherein the PWM signal has a duty cycle equal to or less than 50%.

10. The horticulture lighting device of claim 1, further comprising a memory, the memory having one or more light pattern profiles.

11. The horticulture lighting device of claim 10, wherein the controller determines the pulsed light pattern from a first light pattern profile in the one or more light pattern profiles.

12. The horticulture lighting device of claim 1, wherein the power supply includes a maximum current rating that is less than a sum of the current drawn by each light channel of the light engine circuit when coupled to the power supply.

13. A method for driving a plurality of light channels of a horticulture lighting device, the method comprising:
providing, by driver circuitry, a first signal to a first light channel;
providing, by driver circuitry, a second signal to a second light channel; and
outputting a predetermined light pattern by a plurality of light emitting diodes (LEDs) over a period of time T based at least in part on the first and second signals, the predetermined light pattern including one or more pulse delays to prevent light output by the first and second light channels for a predetermined period of time to cause a biochemical response in a target plant.

14. The method of claim 13, wherein each of the one or more pulse delays measures between 500 microseconds and 5 milliseconds.

15. The method of claim 13, wherein each of the one or more pulse delays measures at least 1 millisecond.

16. The method of claim 13, wherein the first signal and the second signal are each a pulse-width modulated (PWM) signal.

17. The method of claim 13, wherein the predefined light pattern includes a refresh rate between 120 Hz and 720 Hz.

18. The method of claim 13, wherein the first signal and the second signal have an associated duty cycle of 50% or less.

19. The method of claim 13, further comprising selecting a light pattern profile from a memory, wherein the predetermined light pattern is emitted by the plurality of LEDs based on the selected light pattern profile.

20. The method of claim 19, wherein a period for each of the one or more pulse delays is based on the selected light pattern profile.
